(19) United States
(12) Patent Application Publication
(10) Pub. No.: US 2024/0192086 A1
(43) Pub. Date: Jun. 13, 2024

(54) TEST OBJECT HAVING A MEASURING MODULE

(71) Applicant: AVL List GmbH, Graz (AT)

(72) Inventors: Peter Priller, Gratwein-Straßengel (AT); Dominik Heschl, St. Johann in der Haide (AT); Rupert Grüllenberger, Graz (AT)

(21) Appl. No.: 18/287,675

(22) PCT Filed: Apr. 19, 2022
(86) PCT No.: PCT/AT2022/060121

§ 371 Date: Oct. 20, 2023

(30) Foreign Application Priority Data
Apr. 20, 2021 (AT) A50290/2021

(51) Int. Cl. G01M 15/02; G01M 15/05; G06F 17/40

(52) U.S. Cl. CPC G01M 15/02; G01M 15/05; G06F 17/40

(57) ABSTRACT

The aim of the invention is to provide a flexible testing assembly comprising a test object at a testing device for performing a test phase of a test sequence using measured values (M) of the test object. This aim is achieved in that the test object comprises a measuring module, wherein a test sensor is provided in the measuring module and designed to acquire the measured values (M) of the test object. A communications device is provided in the measuring module and designed to transmit the measured values (M) to an evaluation unit of the testing device, wherein the evaluation unit is designed to process the measured values (M) in order to perform the test phase of the test sequence.

The present invention relates to a testing assembly comprising a test object at a testing device for performing a test phase of a test sequence using measured values of the test object, and to a method for performing a test phase of a test sequence.

The acquisition and processing of measured values of a test object plays an important role in many processes, in particular in the field of Research and Development (R&D) as well as Verification and Validation (VV) in the automotive industry. This includes both basic research on operations and material properties, e.g., of drive trains, energy stores, energy converters, etc., and also support of development processes and optimizations, integration, verification, and validation of products, up to research of aging and wear phenomena. In this case, typical test objects are individual components (e.g., engine, transmission, battery), subsystems (e.g., drive trains), or complete vehicles.

A testing device (also referred to as a test apparatus) is provided for acquiring and processing physical measured values of the test object. The testing device comprises the required test sensors and evaluation units, and can be designed as a test bench or also as a mobile testing device, which is installed in a vehicle for example. The measured values are transmitted from the test sensors to the associated evaluation units. The evaluation units process the measured values in order to research, characterize, and/or monitor properties and/or states of the test object. The evaluation units can also carry out signal processing (amplifiers, filters, etc.), analog-to-digital conversion, and data preparation.

During a test sequence, e.g., a development process, a test object passes through tests in different test phases. For the individual test phases, different testing devices are often provided, which can originate from different manufacturers and thus diverge greatly from one another. For example, a distinction is made between Model-in-the-Loop (MiL), Hardware-in-the-Loop (HiL), Software-in-the-Loop (SiL), and Vehicle-in-the-Loop tests. For example, component, drive train, vehicle, emission, or continuous operation test benches are provided for this purpose. Hardware-in-the-Loop test benches are provided in particular for testing test objects in the form of controllers for internal combustion engines, hybrid motors, electric motors, transmissions, batteries, fuel cells, brakes, etc. A test sequence thus comprises at least one, but preferably several, test phases.

Even within a test phase, it may be necessary to change the testing device. For example, the test object can be removed from the testing device for mechanical adaptations, between two test phases, and taken to a workshop. In particular, if the testing device is designed as a test bench, a different test object can be tested in the meantime, on the now free test bench. If the adaptations of the test object located in the workshop have been completed, the test object can be arranged again on a testing device. However, if the previously used testing device is already in use, then a different, free testing device is used for the test object. Although testing devices which are provided for the same test phase are usually constructed identically or similarly, new wiring and configuration of the test sensor, associated with the testing device, with the test object is required when the testing device is changed. It is thus also necessary to check the correct wiring before the next test phase. Thus, even within a test phase, with each change of the testing device, a certain outlay results with regard to the wiring and the testing of the wiring for errors.

The situation is significantly more difficult if the testing device is changed due to entry into a new test phase. The test object is provided, at the new testing device, with other test sensors which are connected to another evaluation unit. The test sensors of different testing devices can acquire the same physical variable or different physical variables. However, the evaluation units differ from testing device to testing device. In all cases, the test object has to be wired to the sensor and to the evaluation unit of the associated testing device for each test phase, and the evaluation unit must be configured accordingly.

In summary, it can be stated that, when the testing device is changed, the sensors of the previously used testing device are first removed from the test object, and the sensors of the next testing device are arranged on the test object. This new arrangement has a risk of error, and must therefore be checked for correctness. Finally—particularly in multi-phase development processes—the change of the test phase is associated with a change in the type of testing device, as a result of which new parameterization of the evaluation unit is required—particularly if functions of the signal processing, analog-to-digital conversion, data preparation, etc., are also taken over at the evaluation unit. The aforementioned effort increases the likelihood of errors, whether by incorrect wiring, or incorrect forwarding of calibration or configuration data.

It is an object of the present invention to improve the provision of measured values of test objects in test sequences having several test phases.

This object is achieved according to the invention in that the test object comprises a measuring module, wherein a test sensor is provided in the measuring module, which test sensor is designed to detect the measured values of the test object, wherein a communications device is provided in the measuring module, which communications device is designed to transmit the measured values to an evaluation unit of the testing device, wherein the evaluation unit is designed to process the measured values for performing a test phase of the test sequence. Furthermore, the object is achieved by a method for performing a test sequence, wherein a first test phase of the test phase is provided with a first testing assembly in which a test object, comprising a measuring module, is arranged on a first testing device, wherein, in the first test phase, a test sensor of a measuring module of the test object acquires measured values of the test object and transmits these via a communications device of the measuring module to an evaluation unit of the testing device, wherein the evaluation unit processes the measured values for performing the first test phase of the test sequence. Of course, the test object can also comprise more than one measuring module. A plurality of test sensors can also be provided in a measuring module. Furthermore, several communications devices—preferably of different types—can be provided in a measuring module. Different standards, e.g., Bluetooth and WiFi, can thus be supported.

Operating sensors can be provided, like test sensors, on the test object, but are designed only for the operation of the test object and not for performing a test phase. The test sensors differ from operating sensors by increased accuracy, faster readout frequencies, and not least by their higher price. Operating sensors are usually installed as standard in vehicle components (e.g., transmission, engine, gasoline pump, battery, etc.), the specification of which operating sensors (measurement range, accuracy, resolution, temperature response, bandwidth, etc.) is sufficient for use in normal operation (e.g., for engine control). However, in order to be able to analyze these vehicle components as a test object at a testing device (for example, for an optimization, a further development, or also a certification of the vehicle component in question), the test sensors used for this purpose must have better specifications than the installed operating sensors. With regard to accuracy, an order of magnitude (factor 10) can be specified, and a factor of 2 . . . 5 in other specifications. For test sensors for determining temperatures, a maximum measurement error of 0.1° C. can be provided, for example, in a measurement range of −50° C. to 200° C.

Since a measuring module comprising a test sensor and comprising a communications device connected to the test sensor are provided on the test object, it is not necessary to arrange a test sensor, which is associated with the testing device, on the test object before a test phase is carried out. Rather, it is sufficient if a connection to the evaluation unit of the testing device is established by means of the communications link of the measuring module. In the measuring module, measured values are determined by the test sensor, which are transmitted to the evaluation unit by means of the communications link. Potential errors in the attachment of the test sensor to the test object are thereby avoided. In addition, the handling of the test setup is substantially simpler and more efficient.

Preferably, the first test phase of the test sequence is terminated, wherein the test object is removed from the first testing device, and a second test phase of the test sequence is provided, using a second testing assembly in which the test object is arranged on a second testing device, wherein, in the second test phase of the test sequence, the test sensor of the measuring module of the test object acquires measured values of the test object and transmits these via the communications device of the measuring module to an evaluation unit of the second testing device, wherein the evaluation unit processes the measured values for performing the test phase. Since the test object comprises the measuring module, the measuring module together with the test object is removed from the first testing device after the first test phase. Since the test object is already instrumented (i.e., provided with test sensors), a change between different testing assemblies, i.e., a change of the testing devices, is possible, even between different test phases, without the above-mentioned additional outlay for arranging and reconfiguring the test sensors. The test sensor and its connection to the communications unit are not manipulated further in this case. Thus, not only in the case of a change of the testing device within a test phase, but also over different test phases, the identical test sensors, provided on the test object, are always used, which delivers consistent and comparable measured values without the need for calibration or comparative measurements of different test sensors. It is thus possible to supply the acquired measured values of the same test sensors in a wide variety of evaluation units of different testing devices, without an intervention in the test object. The fact that the aforementioned error sources are avoided is not insignificant. It can also be provided that functions which, according to the prior art, were associated with the evaluation unit, be able to be shifted to the measuring module—for example, functions of the signal processing, analog-to-digital conversion, data preparation, etc.

The measuring module is preferably an integral component of the test object. Preferably, the measuring module is installed on the test object before the start of the test sequence, and preferably already during the construction of the test object itself. The measuring module thus remains on the test object over several test phases.

The measuring module can be integrated into a housing of the test object. Thus, for example, the measuring module together with the test sensor and the communications unit can already be installed in the housing during assembly of the test object.

Furthermore, the measuring module can be integrated, for example, into a housing of the test object, and can thus be an integral component of the test object.

In an advantageous embodiment of a measuring module, a measuring module installed on or in the test object can be left on or in the test object during all test phases, and can thus be an integral component of the test object.

However, a measuring module can, for example, also be non-detachably connected to the test object, and thereby be an integral component of the test object. In this case, a non-detachable connection is preferably to be understood as a connection which cannot be released again without (at least partial) damage to the remaining substance of the test object.

It is advantageous if the measuring module is non-detachably integrated into the test object. The measuring module thus cannot be removed from the test object without destruction. For this purpose, the measuring module can be integrated into the test object in the course of a production process of the test object, e.g., already in the construction of prototypes in component manufacture—for example by integrating a strain gage (test sensor for measuring a force) within a multilayer bearing shell (test object). It can thus be advantageous to use additive manufacturing steps (AM—additive manufacturing). The measuring module thus remains in or on the test object for the entire lifetime of the test object. Of course, this leads to higher costs, which is why measuring modules which are non-detachably integrated into the test object are advantageous—in particular, for test objects which are prototypes, or individual selected test objects. Measuring modules which are non-detachably integrated into the test object, however, are also fundamentally conceivable for series production.

The communications device is preferably designed to wirelessly transmit the measured values to the evaluation unit. In this case, the measuring module can also be referred to as a wireless sensor node (WSN). By wireless transmission of the measured values, contact errors (intermittent contacts, contact transition resistances, scattering of interference) can be avoided, compared to wired transmission of the measured values. In addition, the connection of the communications device to the evaluation unit can be established more easily. Since, in this preferred embodiment of the test object, the measuring module comprises the test sensor and the communications device, and, in addition, the communications device is designed to wirelessly transmit the measured values to the evaluation unit, a change of the testing device can conceivably be performed in a simple manner. Only a wireless connection between the communications device and the evaluation unit has to be established, as a result of which no manipulation of the test sensor or establishment of plug connections is required.

The measuring module can comprise an analog-to-digital converter for converting analog measured values into digital measured values, wherein the communications device is designed to transmit the digital measured values to the evaluation unit. The susceptibility to faults during the transmission of the digitized measured values is thus reduced, and no analog-to-digital conversion of the measured values at the evaluation unit is required.

The measuring module can further comprise a signal processing unit for processing measured values. The signal processing unit can in turn contain a computing unit (e.g., a CPU), on which a conversion and/or calibration and/or linearization and/or a pre-evaluation of the measured values can take place, as a result of which these and further functions do not have to be performed by the evaluation unit. For example, encryption of the measured values can also be performed on the basis of the signal processing unit, using cryptographic methods. If an analog-to-digital converter is provided, a signal processing unit can be provided in front of the analog-to-digital converter, in order to process the analog measured values, and/or a signal processing unit can be provided after the analog-to-digital converter, in order to process the digital measured values.

Advantageously, the measuring module comprises a—preferably non-volatile—memory unit for storing measured values. Thus, acquisition of measured values is also possible independently of an evaluation unit and without an arrangement on a test device. Preferably, the measured values are encrypted by cryptographic methods before being stored.

For example, the measuring module can be configured to acquire measured values permanently or in portions using the test sensor, and to store these in the memory unit, in order to record the measured values in the memory unit. This can take place during the transmission of the data to the evaluation unit, but also additionally or instead, if the communications unit of the measuring module is not connected to any evaluation unit of a test device.

However, the measuring module can also be configured such that the measured values are stored in the memory unit only outside of, e.g., between, the test phases (e.g., during modification or storage of the test object), i.e., without a connection of the communications device. A continuous recording of the measured values is thus also ensured, since the measured values are recorded, upon connection of the measuring module (via the communications device) to an evaluation unit of a testing device, on the basis of the evaluation unit, and, when the measuring module is not connected to an evaluation unit, the measured values are recorded in the memory unit.

Furthermore, the measuring module can comprise a power supply unit, and preferably an energy harvesting unit and/or a long-term energy store, for supplying power to the measuring module. In this way, no external power supply is required for supplying power to the measuring module, which is particularly advantageous in conjunction with a memory unit. Energy harvesting denotes the production of electrical energy from environmental effects, and in particular microeffects such as vibrations (e.g., by means of piezoelectric crystals), temperature differences (e.g., by means of pyroelectric crystals), electromagnetic radiation (e.g., by means of passive RFID's), photovoltaics, osmosis, etc. Energy harvesting units are also referred to as nanogenerators. If the measuring module comprises further submodules, such as an identification unit, a locating unit, a memory unit, etc., it is advantageous if at least some of these submodules are supplied with power by the power supply unit.

Preferably, the measured values are transmitted to a display unit, e.g., via the communications device, and visualized thereon. The display unit can also be independent of the evaluation unit or the testing device.

The test sensor can be designed to acquire at least one of the following measured values of the test object: pressure, temperature, rotational speed, torque, current, voltage, gas concentration, velocity, acceleration, force, particle concentration, humidity.

Advantageously, the measuring module comprises an identification unit which is designed to provide functions and/or properties of the measuring module with respect to external systems, e.g., the testing device, wherein the identification unit preferably is configured according to the Transducer Electronic Data Sheet (TEDS) functionalities according to the ISO/IEC/IEEE 21450:2010 standard. This makes it possible to provide the measured values in the correct format and semantically correctly to the different evaluation units of different testing devices (which can possibly also originate from different manufacturers). Preferably, the functions and/or properties are provided wirelessly. This provision of the functions and/or properties of the measuring module can take place, for example, via the communications device.

In order to ensure a functional integration of the measuring module into the testing device, it is advantageous if the functionality NCAP (network capability application processor) described in the ISO/IEC/IEEE 21451 standard is implemented on the part of the testing device. The measured values transmitted from the measuring module to the testing device (i.e., from the test sensor, by means of the communications unit, to the evaluation unit of the testing device) are thus assigned to the appropriate data sinks of the evaluation unit of the testing device.

Advantageously, the measuring module comprises a locating unit, which is designed to disclose the position of the measuring module on the test object. For this purpose, a position signal can be transmitted to the evaluation unit—preferably by means of the communications device. If this positioning can be assigned to a predefined measuring point (e.g., one stored in a list), the type of test sensor and/or of the measured value, and possibly further information, such as measurement ranges that should advantageously be selected (e.g., 0 . . . 1,000° C.), sampling rates (e.g., 1 Hz), filter settings, and an associated designation (e.g., “T_CYL_2” for temperature at the outlet of the cylinder 2), can be determined therefrom. Thus, an association between the test sensor and the measured value can take place, or a corresponding existing association can be checked (e.g., based upon manual input) in an automated manner.

If the position of the measuring module on the test object is known, locating the test object (“where at the test device?” and/or also globally, i.e., “at which test device?”) is thus possible on the basis of the known position of the measuring module. This is advantageous in the case of automatic documentation of the test sequence of a test object—for example, by determining at what time the test object is located at which testing device, etc.

The locating unit preferably comprises a visual signal output unit which outputs a visual signal (e.g., a light-emitting diode or another light source) for determining the positioning of the measuring module. For this purpose, an optical sensor (e.g., a camera) can be provided on the test bench, which locates the measuring module in space on the basis of the visual signals emitted by the visual signal output unit.

The locating unit can also be designed to determine the position of the measuring module using a radio signal. For example, a radio signal can be transmitted from a stationary radio transmitter (for example, provided at the testing device) and received by the locating unit, as a result of which the locating unit can determine the position of the measuring module. Alternatively, a radio signal can also be transmitted from the locating unit to a stationary radio receiver, as a result of which the radio transmitter can determine the position of the measuring module. In both cases, for example, a transit time and/or a signal strength and/or an angle of incidence, etc., of the radio signal can be consulted for determining the position. For example, RFID tags, UWB tags, etc., can be used as radio signals.

Preferably, measured values are encrypted by cryptographic methods and transmitted to the evaluation unit in encrypted form by the communications unit. Measured values can thus be decrypted and used only by certain (“trusted”) evaluation units. Thus, the data superiority over the measured values initially remains in the case of the test object. Access to the measured values is possible only by authorized testing devices.

A plurality of measuring modules can also be provided on the test object, the measured values of which measuring modules are linked to one another in order to increase the integrity of the measured values. Since the measuring modules remain on the test object over a longer period of time, and optionally the entire lifetime of the test object, the measuring modules can link the measured values of adjacent nodes at the current or a preceding time step with their own current measured value at the current or a preceding time step, and secure them—preferably via a cryptographic hash transmitted therewith. This results in a cohesive chain similar to a blockchain, which can serve as strong evidence of integrity. This can take place as follows: on the basis of its measured values, each test sensor provides “its view” on the processes in the test object. If the sensors are located on the same test object, there is in many cases a correlation of these “views.” This can be used as an indication that the sensors are indeed located on the same test object. This correlation can take place in the evaluation unit or even locally in the respective measuring modules, if these also receive the measurement values of adjacent measuring modules. The correlation of the measured values can be used at the measuring module or in the evaluation unit for determining the authenticity of the measurements.

Up to now, only testing assemblies have been described in which the evaluation unit is associated with the testing device. However, in principle an evaluation unit independent of the testing device can also be provided in a testing assembly, wherein the test object comprises a measuring module which has a test sensor which is designed to acquire the measured values of the test object, wherein a communications device furthermore is provided in the measuring module, which communications device is designed to transmit the measured values to the evaluation unit that is independent of the testing device.

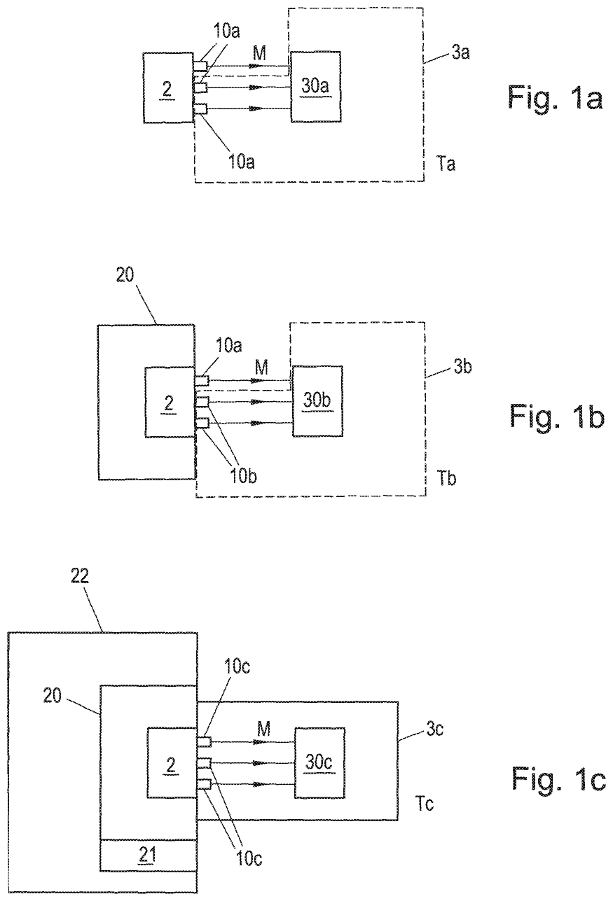

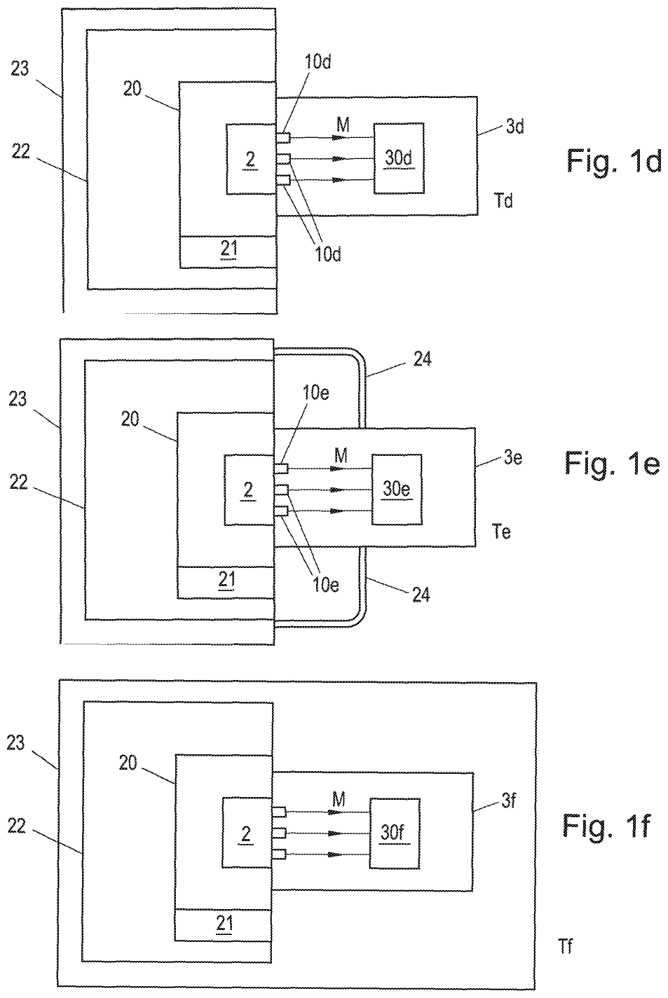

The present invention is described in more detail in the following with reference to FIGS. 1, 2, and 3, which schematically show advantageous embodiments of the invention by way of example and in a non-limiting manner. In the figures:

FIGS. 1a-f show testing assemblies with a test object on a testing device according to the prior art,

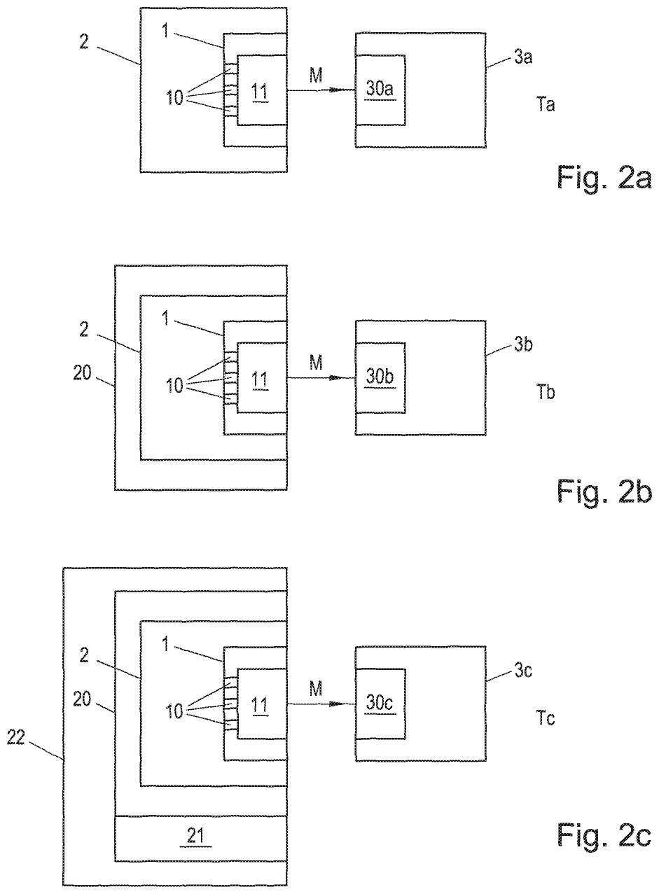

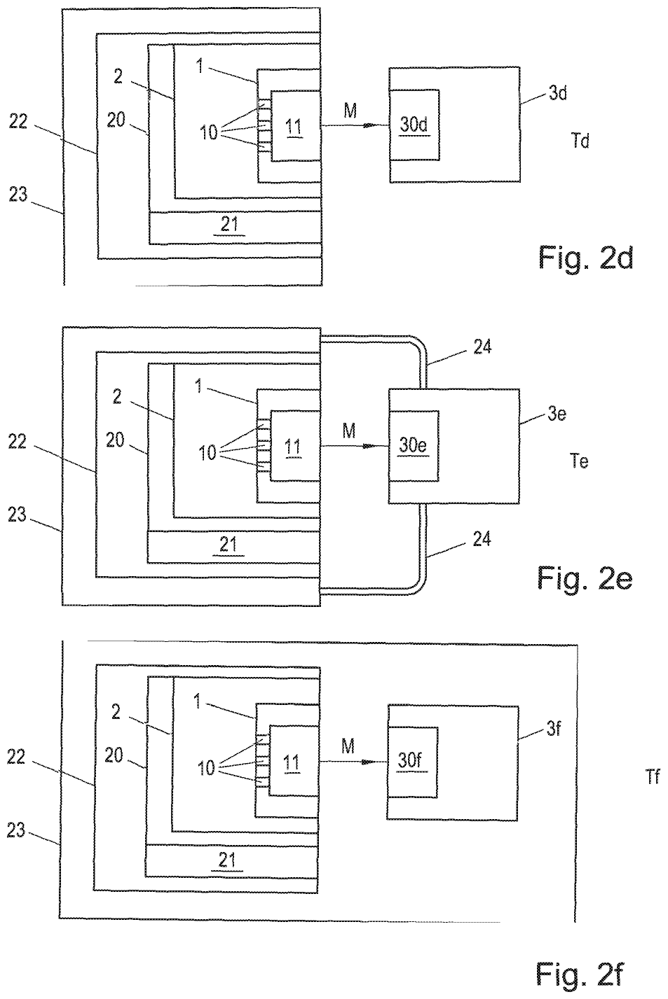

FIGS. 2a-f show testing assemblies according to the invention with a test object on a testing device, wherein a measuring module having test sensors and a communications device is provided on the test object,

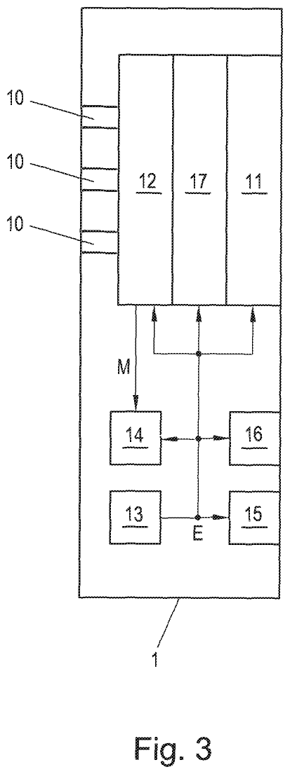

FIG. 3 shows a test object, wherein the measuring module advantageously comprises an analog-to-digital converter, an energy supply unit, a locating unit, and an identification unit, wherein the communications device is designed to transmit digital measured values M.

A test object is arranged, in a test phase, on a testing device 3, wherein the testing device 3 together with the test object 2 is regarded as a testing assembly. A test sequence comprises at least one, but preferably a plurality of, test phases. FIGS. 1a-f show testing assemblies of a test sequence in the form of six test phases Ta, Tb, Tc, Td, Te, Tf according to the prior art. In contrast, FIGS. 2a-f show the testing assemblies according to the invention of this test sequence in the form of six test phases Ta, Tb, Tc, Td, Te, Tf. In the testing assemblies according to the prior art, in each case test sensors 10 are provided on the testing device 3 in order to detect measured values M of the test object 2. These test sensors 10 are arranged on the test object 2 in order to perform a test phase. The measured values M are determined on the basis of the test sensors 10, and transmitted to an evaluation unit 30 connected to the test sensor 10. Just like the evaluation unit 30, the test sensors 10 are part of the testing device 3.

According to the prior art, the evaluation unit 30 assumes the processing of the measurement data M and, if necessary, also functions of the signal processing, analog-to-digital conversion, data processing, data display, data storage, etc., and must be appropriately configured/parameterized after the test sensors 10 are attached to the test object 2.

An automation unit can also be provided, which controls the testing device in accordance with predefined test requirements (not shown in the figures).

If it is now intended for the test object 2 to be connected to another testing device 3, the test sensors 10 of the testing device 3 are separated from the test object 2, and the test object 2 is connected to test sensors 10 of a further testing device 3. When the testing device 3 is changed, there is thus the risk of wiring errors, configuration errors, of the test sensor 10, etc.

By way of example, an injection pump of a diesel engine is considered as the test object 2. Furthermore, it is assumed that six test phases Ta, Tb, Tc, Td, Te, Tf for the test object 2 are provided in the test sequence, wherein the test object 2 is arranged on a different testing device 3a, 3b, 3c, 3d, 3e, 3f in each test phase Ta, Tb, Tc, Td, Te, Tf. In each test phase Ta, Tb, Tc, Td, Te, Tf, the test object 2 is connected to a different testing device 3a, 3b, 3c, 3d, 3e, 3f in order to perform one test phase in each case. FIGS. 1a-f show the testing assemblies in the course of these six test phases Ta, Tb, Tc, Td, Te, Tf according to the prior art, whereas FIGS. 2a-f show the testing assemblies according to the invention in the course of these six test phases Ta, Tb, Tc, Td, Te, Tf.

In the testing assemblies according to the prior art, test sensors 10a, 10b, 10c, 10d, 10e, 10f are provided on the test device 3a, 3b, 3c, 3d, 3e, 3f in each case, in order to acquire measured values M of the test object 2. For this purpose, in the corresponding test phases Ta, Tb, Tc, Td, Te, Tf, the test sensors 10a, 10b, 10c, 10d, 10e, 10f of the associated testing device 3a, 3b, 3c, 3d, 3e, 3f are arranged on the test object 2. The measured values M are determined on the basis of the test sensors 10a, 10b, 10c, 10d, 10e, 10f and transmitted to an evaluation unit 30a, 30b, 30c, 30d, 30e, 30f of the associated testing device 3a, 3b, 3c, 3d, 3e, 3f.

In the first test phase Ta, the test object 2 is thus developed and tested on a first testing device 3a—for example, a component test bench from the manufacturer A. For this purpose, the test object 2 is connected to test sensors 10a (e.g., pressure sensors, temperature sensors) of the testing device 3a.

In the prior art, test sensors 10 are also known which are not an integral component of the testing device 3, but, rather, external components. These test sensors 10 not only have to be arranged on the test object 2, but also have to be connected to the evaluation unit 30 of the testing device 3. Testing assemblies can also be provided in which test sensors 10 are provided which are integrated into a testing device 3 (e.g., temperature sensors for acquiring the intake air temperature of an engine), as well as external test sensors 10 (e.g., temperature sensors for acquiring an oil temperature of the engine). In FIG. 1a, by way of example, the uppermost test sensor 10a is provided externally, wherein the further two test sensors 10a are provided internally in the first testing device 3a, i.e., as an integral component of the testing device 3a.

A measuring module 1 can be integrated into a housing of the test object 2 and can thus be an integral component of the test object 2. For example, the measuring module 1 together with the test sensor 10 and the communications unit can already be installed, as an integral component, in the housing during assembly of the test object 2. In an advantageous embodiment, a measuring module 1 installed on or in the test object 2 can be left on or in the test object 2 during all test phases, and can thus be an integral component of the test object 2. A measuring module 1 can, for example, be non-detachably connected to the test object 2, and can thereby be an integral component of the test object 2. In this case, a non-detachable connection is preferably to be understood as a connection which cannot be released again without at least partially damaging the remaining substance of the test object 2.

In the second test phase Tb, the injection pump, as a test object 2, is mounted on a diesel engine 20. The diesel engine 20 together with the test object 2 is tested on a second testing device 3b—for example, an engine test bench of the manufacturer B. During a change from the first testing device 3a (FIG. 1a) to the second testing device 3b (FIG. 1b), at best some of the (external) test sensors 10a (e.g., a Pt100 temperature sensor) can remain on the test object 2, as indicated in FIG. 1b on the basis of the external (i.e., the uppermost) test sensor 10a. This test sensor 10a is then newly connected to an evaluation unit 30b of the second testing device 3b, which also requires a new configuration (and possibly also calibration).

In the third test phase Tc (FIG. 1c), the diesel engine 20 is joined to a transmission 21 to form a drive train 22, wherein it is possible for this third test phase to be carried out on a different testing device 3c, e.g., a drive train test bench of the manufacturer C, and possibly even in another testing laboratory. Complete rewiring of the test object 2 with test sensors 10c of the third testing device 3 and reconfiguration of the evaluation unit 30c connected to the test sensors 10c are thus required.

Subsequently, the drive train 22 is installed in a vehicle 23, and a fourth test phase Td is introduced at a fourth testing device 3d, e.g., a rolling test bench from the manufacturer D (FIG. 1d). A further rewiring of the test object 2 with test sensors 10d of the fourth testing device 3d, and corresponding parameterization of the evaluation unit 30d of the fourth testing device 3d, takes place. In the fourth test phase Td, a sub-phase for vehicle conditioning can also be provided, in which, before the actual fourth test phase, vehicles are cooled to certain temperatures (e.g., −25° C.) (“soak”). This can be carried out in a specially-equipped sub-region of the fourth testing device 3d, known as the “soak area.” A continuous acquisition of the measured values M (e.g., engine oil temperature, cooling water temperature) is also required during the sub-phase. These measured values M are made available to a specialized system (soak area control) for regulation and monitoring of this sub-phase. For the sub-phase, the same sensors 3d can be used as for the fourth test phase Td, wherein a sub-evaluation unit that is different from the fourth evaluation unit 30d is provided, however.

In the fifth test phase Te, for example, test drives of the vehicle 23 are carried out on a test route or on public roads—for example, in order to perform exhaust gas tests under real driving conditions (RDE—real driving emission). In this case, for example, a mobile testing device 3e from the manufacturer E is used, which is carried along in the vehicle 23, as is indicated by way of example in FIG. 1e by the fastening elements 24. A further rewiring of the test object 2 with test sensors 10e, and a parameterization of an evaluation unit 30e of the fifth test device 3e, is thus required.

Finally, a sixth test phase Tf is provided for researching reliability, wear, and aging in “normal” driving operation—possibly as part of a fleet test. Since this can take place over a long time (month or years) and using a larger number of test objects 2, a different, sixth, testing device 3f (integrated into the vehicle 23—for example, via the channels of control units) from the manufacturer F is used. This is indicated in FIG. 1f by the sixth testing device 3f being shown as part of the vehicle 23.

In summary, according to the prior art, the test sensors 1a, 1b, 1c, 1d, 1e, 1f of the respective testing device 3 must be arranged on the test object 2 for each testing device 3a, 3b, 3c, 3d, 3e, 3f, and thus also for each test phase, and the evaluation unit 30a, 30b, 30c, 30d, 30e, 30f of the respective testing device 3a, 3b, 3c, 3d, 3e, 3f must be configured.

In contrast, FIGS. 2a through 2f show testing assemblies according to the invention, compared to FIGS. 1a through 1f. The test object 2 is likewise connected, per test phase, to the testing device 3a, 3b, 3c, 3d, 3e, 3f associated with the test phase, in order to perform a test sequence. In this case, measured values M are determined, in the same way, on the basis of test sensors 10 during the individual test phases of the test sequence. In contrast to FIGS. 1a through 1f, in FIGS. 2a through 2f, a measuring module 1 is provided on the test object 2. The measuring module 1 comprises a test sensor 10 which is thus likewise arranged on the test object 2. In addition, the measuring module 1 comprises a communications device 11 which transmits the acquired measured values M to the evaluation unit 30. The construction of the testing assemblies in FIGS. 2a through 2f thus takes place in each case by the communications device 11 being connected to the evaluation unit 30. The test sensors 10 are already provided on the test object 2. It is thus not necessary (after an initial installation) to arrange the test sensors 10, for performing the corresponding test phases Ta, Tb, Tc, Td, Te, Tf, on the test object 2, as a result of which the resulting outlay is less, and, in addition, a possible source of errors of incorrect wiring is eliminated. The communications devices 11 shown in FIGS. 2a-f are advantageously further designed for wireless transmission of the measured values M, which represents a particularly advantageous embodiment.

If it is provided for the test object 2 to be connected to another test device 3b, 3c, 3d, 3e, 3f (for example, when changing the test phase Ta, Tb, Tc, Td, Te, Tf), the measuring module 1, and thus also the test sensors 10 (and the communications device 11), thus remain on the test object 2. Only the (wired or wireless) communications link from the communications device 11 to the first testing device 3a is cut, and a communications link from the communications device 11 to the other testing device 3b, 3c, 3d, 3e, 3f is then established.

In summary, according to the invention, the test object 2 comprises the measuring module 1, which can also be permanently and non-detachably integrated into the test object 2.

In another embodiment, the measuring module 1 can also be detachably connected to the test object 2, as a result of which the measuring module 1 can be provided on the test object 2 only during the test runs, and can be removed again after the test runs.

The measuring module 1 comprises a number of test sensors 10 for acquiring the measured values M. Thus, the measuring module 1, and thus also the number of test sensors 10, are assigned to the test object 2 (and not to the testing device 3), and are also left there during all the test phases Ta, Tb, Tc, Td, Te, Tf or (especially when they are an integral component of the test object 2) also beyond these phases. A communications device 11 is provided in the measuring module 1 for the—preferably wireless—transmission of the measured values M to the evaluation unit 30.

FIG. 3 discloses a particularly advantageous embodiment of a measuring module 1, which assumes functions of the evaluation unit 30. This can be done using sub-units. For example, an analog-to-digital converter 12 for converting analog measured values M into digital measured values M is provided as a sub-unit, wherein the communications device 11 is designed to transmit the digitized measured values M to the evaluation unit 30. In addition, the measuring module 1 advantageously comprises, as a sub-unit, a—preferably non-volatile—memory unit 14 for storing measured values M. The measuring module 1 further comprises, as a sub-unit, a signal processing unit 17 for processing the measured values M. Furthermore, the measuring module 1 can comprise, as a sub-unit, an identification unit 15 which is designed to provide functions and/or properties of the measuring module, and/or can comprise, as a sub-unit, a locating unit 16 which is designed to disclose the position of the measuring module 1 on the test object 2.

In addition, the measuring module 1 can comprise, as a sub-unit, a power supply unit 13, and preferably an energy harvesting unit and/or a long-term energy store, for supplying the measuring module 1 with energy E. In FIG. 3, the power supply unit 13 is connected to the further sub-units, i.e., the analog-to-digital converter 12, the memory unit 14, the identification unit 15, the locating unit 16, and the signal processing unit 17, in order to supply said sub-units with energy E.

1. A testing assembly comprising:
a test object at a testing device for performing a test phase of a test sequence using measured values of the test object, wherein the test object comprises a measuring module, wherein a test sensor is provided in the measuring module, which test sensor is designed to acquire the measured values of the test object; and
a communications device provided in the measuring module, which communications device is designed to transmit the measured values to an evaluation unit of the testing device, wherein the evaluation unit is designed to process the measured values in order to perform the test phase of the test sequence and, wherein the measuring module is an integral component of the test object.

2. (canceled)

3. The testing assembly according to claim 1, wherein the measuring module is integrated into a housing of the test object.

4. The testing assembly according to claim 2, wherein the measuring module is non-detachably integrated into the test object.

5. The testing assembly according to claim 1, wherein the communications device is designed to wirelessly transmit the measured values to the evaluation unit.

6. The testing assembly according to claim 1, wherein the measuring module includes an analog-to-digital converter for converting analog measured values into digital measured values, and wherein the communications device is designed to transmit the digital measured values to the evaluation unit.

7. The testing assembly according to claim 1, wherein the measuring module includes a non-volatile, memory unit for storing measured values.

8. The testing assembly according to one of claim 1, wherein the measuring module includes a signal processing unit for processing measured values.

9. The testing assembly according to one of claims 1 through 8, wherein the measuring module includes a power supply unit, an energy harvesting unit, and a long-term energy store, for supplying power to the measuring module.

10. The testing assembly according to claim 1, wherein the test sensor is designed to detect measured values of the test object, selected from the group consisting of pressure, temperature, rotational speed, torque, current, voltage, and gas concentration.

11. The testing assembly according to claim 1, wherein the measuring module includes an identification unit which is configured to provide functions or properties of the measuring module, wherein the identification unit is configured according to the Transducer Electronic Data Sheet functionalities according to the ISO/IEC/IEEE 21450:2010 standard.

12. The testing assembly according to claim 1, wherein the measuring module includes a locating unit which is configured to disclose the position of the measuring module on the test object and to transmit it to the evaluation unit by means of the communications device.

13. The testing assembly according to claim 12, wherein the locating unit includes a visual signal unit for disclosing the position of the measuring module.

14. The testing assembly according to claim 12, wherein the locating unit includes a radio unit for disclosing the position of the measuring module.

15. A method for performing a test sequence, comprising:
providing a first test phase of the test sequence including a first testing assembly, in which a test object, including a measuring module, is arranged on a first testing device, that, in the first test phase of the test sequence, a test sensor of the measuring module of the test object acquires measured values (M) of the test object and transmits these to an evaluation unit of the testing device via a communications device of the measuring module;
processing, with the evaluation unit, the measured values for performing the first test phase of the test sequence, wherein the first test phase of the test sequence is ended, wherein the test object is removed from the first testing device, in that a second test phase of the test sequence having a second testing assembly is provided, in which the test object is arranged at a second testing device, and in that, in the second test phase of the test sequence, the test sensor of the measuring module of the test object acquires measured values of the test object and transmits these to an evaluation unit of the second testing device via the communications device of the measuring module, wherein the evaluation unit of the second testing device processes the measured values for performing the second test phase.

16. (canceled)

17. The method according to claim 15, wherein the measured values are encrypted, using cryptographic methods, before transmission to the communications device.

18. The method according to claim 15, wherein the measured values are secured in a non-volatile-memory unit of the measuring module, and are encrypted beforehand using cryptographic methods.
